(19) United States
(12) Patent Application Publication
(10) Pub. No.: US 2007/0134381 A1
(43) Pub. Date: Jun. 14, 2007

(54) Decorative band, food packaging comprising one such band and production method thereof

(75) Inventor: Jakob Socher, Brannenburg (DE)

Correspondence Address: YOUNG & THOMPSON, 745 SOUTH 23RD STREET, 2ND FLOOR, ARLINGTON, VA, 22202, US

(73) Assignee: COMPAGNE GERVAIS DANONE, Levallois-Perret (FR)

(21) Appl. No.: 10/577,724

(22) PCT Filed: Oct. 21, 2004
(86) PCT No.: PCT/FR04/02698

§ 371 Date: May 2, 2006

(30) Foreign Application Priority Data
Nov. 3, 2003 (FR) 0312863

(51) Int. Cl. A23G 3/28

(52) U.S. Cl. 426/383

(57) ABSTRACT

A decorative band which is designed to surround the periphery of food packaging includes a lateral annular wail which extends between a base and an upper face. The band extends longitudinally between two ends and has first and second longitudinal edges. Moreover, the band includes at least one first longitudinal portion having a maximum width and at least one second portion having a minimum width, the minimum width being at most equal to two thirds of the maximum width. A packaging which is equipped with one such band, a method of cutting the band and to a method of producing the packaging are also disclosed.

### FIELD OF THE INVENTION

The present invention relates to a decorative band intended for surrounding the periphery of a food packaging. More particularly, the packing comprises a lateral annular wall extending between a bottom and an upper face, while the band extends longitudinally between two ends and has a first and a second longitudinal edge.

### BACKGROUND

This type of band generally comprises a logo representing the brand of the product and, if appropriate, an image depicting the contents and information on the composition of the product. These bands are intended for surrounding the periphery of the lateral wall of the packaging in such a way that the ends of the band overlap one another or butt against one another. That the band completely surrounds the packaging satisfies esthetic criteria, but also improves the hold of the band on the packaging with respect to the labels and prevents it from being torn off.

Decorative bands are very commonly used for packagings containing dairy products, such as, for example, yoghurts or butter, but also products, such as stewed fruit or margarine.

The upper face of the packaging is provided with an aperture which can be closed by means of a tear-off cap in the case of packagings of the yoghurt pot type or by means of a removable lid, as is used most often for packagings intended for containing margarine. The pot which forms the bottom, the lateral wall and, if appropriate, part of the upper face of the packaging is generally produced by thermoforming from a plastic sheet in a mold. This production method makes it possible to produce particularly inexpensive packagings in very large quantities, while at the same time adhering to the hygiene standards necessary for food products.

Decorative bands have hitherto had an elongate rectangular shape, that is to say they have first and second rectilinear and parallel longitudinal edges. They are generally cut out from a strip of film material, such as paper or plastic film, which is printed and stored in the form of a roll, before the bands are cut out.

The food packagings of this type are produced in very large quantities and are intended for highly competitive markets. It is therefore important as far as possible to reduce the unit cost of each packaging, but without impairing its strength and its esthetic characteristics.

### SUMMARY OF THE INVENTION

The present invention is therefore aimed at reducing the unit cost of these packagings clad in a decorative band.

For this purpose, the decorative band of the abovementioned type has at least one first portion extending longitudinally, which has a maximum width, and at least one second portion, which has a minimum width, said minimum width being at most equal to two thirds of the maximum width.

By virtue of this arrangement, the quantity of film material, whether paper or plastic film, used for producing the band is smaller than that used for producing a rectangular band having a width equal to the maximum width, this being a reduction in material which, of course, makes it possible to reduce the cost of the band. This reduction in material also makes it possible to reduce the weight of the packaging, this having a beneficial influence on the transport and recycling of the packagings. That the area of the band is reduced likewise makes it possible to reduce the area of the printed decorations and consequently to make savings in terms of ink.

Moreover, the band thus produced can still completely surround the packaging, so as to maintain a high quality of fastening of said band, and be employed in the methods currently used for applying the band to the packaging.

In preferred embodiments of the band, moreover, all or any one of the following arrangements may be adopted:
the first longitudinal edge is rectilinear and substantially parallel to the longitudinal axis of the band, this first rectilinear edge then making it possible to guide the band in the conveying devices currently used, without any appreciable modification of these;
the second edge has a convex profile along the first portion and a concave profile along the second portion, said convex profile being complementary to said concave profile, in order to form, in a film material, the second edges of a first and of a second band by the execution of a single cutting line;
the second edge has the profile of a continuous wavy line;
the minimum width is at least equal to one third of the maximum width, in order to maintain a tensile strength which prevents the band from being torn when it is being conveyed during the production cycle;
the maximum width is substantially equal to the maximum height of the lateral wall of the food packaging.

The band defined above can be produced from a strip of film material comprising designs which defined, in the direction of the width of the strip, the contour of an even number of rows of said bands which are arranged such that the second edges of the bands of two successive rows are adjacent, and such that the first edge of the first row and the first edge of the last row are contiguous to the longitudinal edges of the strip, so as to have no waste in the strip after the bands have been cut out.

A food packaging having a lateral annular wall extending between a bottom and an upper face is advantageously surrounded on the periphery of the lateral wall by a decorative band, as defined above, in order to reduce the overall cost of this packaging.

Should the lateral annular wall of such a packaging have a cross section which is substantially in the shape of a rectangle with rounded corners, the first portion of the maximum width of the band is arranged on a large side of the lateral wall of the packaging, so that this portion of the band is clearly visible.

In a method for the production of the band defined above, which comprises a step of cutting out the longitudinal edges of the bands, both or either one of the following arrangements may be adopted:
at least the cutting out of the second edge of the bands is carried out by means of a device comprising at least one movable laser beam which makes it possible to form varied and relatively complex cut-out lines;
the cutting out of the longitudinal edges of the bands is carried out in a strip of film material, as defined above, which travels with respect to the laser cutting-out device, the movements of the laser beam being synchronized with the travel of the strip.

In a method for the production of packaging provided with a band according to the invention, and which comprises a step of thermo forming the packagings in molds, it is advantageous to include a step of cutting out the longitudinal edges from a strip, as defined above, followed by a step of delivering the striplets thus obtained as far as the mold, and by a step of cutting out the ends of the bands, which is carried out in the vicinity of the molds.

### BRIEF DESCRIPTION OF THE DRAWINGS

Other characteristics and advantages of the invention will become apparent from the following description given by way of nonlimiting example, with reference to the accompanying drawings in which:

FIG. 1 is a front view of a first embodiment of a band according to the invention;

FIG. 2 is a view, similar to FIG. 1, of a second embodiment of a band according to the invention;

FIG. 3 is a diagrammatic view of a strip of film material, from which bands according to the invention can be cut our;

FIGS. 4 and 5 are respectively a front view and a side view of a food packaging surrounded by a band according to the invention;

FIG. 6 is a partial diagrammatic view of a production line for the packagings illustrated in FIGS. 4 and 5.

The same references have been retained in the various figures in order to designate identical or similar elements.

### DETAILED DESCRIPTION OF THE INVENTION

FIG. 1 illustrates a decorative bands intended for surrounding the periphery of a food packaging. The band 1 is produced from a film material, that is to say thin and flexible material, such as, for example, paper or a plastic film, in particular from a thermoplastic, such as polypropylene. The selection of a particular material is determined, inter alia, according to the conditions of use of the packaging and as a function of the method of fastening the band to the packaging. Fastening may be carried out, in particular, by the complete or partial gluing of the band or by welding in the event that it is fastened during the thermoforming of the packaging pot.

The band extends longitudinally over a length 1 between ends 2. The length 1 is determined as a function of the perimeter of the packaging for which the band is intended. This length may be exactly equal to the perimeter, so that the ends 2 butt one against the other, or may be slightly greater than the perimeter, so as to have an overlap of the ends.

In addition to the two ends 2, the band is delimited by a first longitudinal edge 3 and a second longitudinal edge 4.

The band 1 has various contiguous portions which extend along the longitudinal axis of the band. In the embodiment illustrated, these portions comprise two first portions 10 and 11 which have a maximum width L1. The portions 10 and 11 are also hereafter called portions of maximum width. The band likewise comprises two second portions 20 and 21 interposed between the first portions 10 and 11 and having a minimum width L2, also hereafter called portion of reduced width.

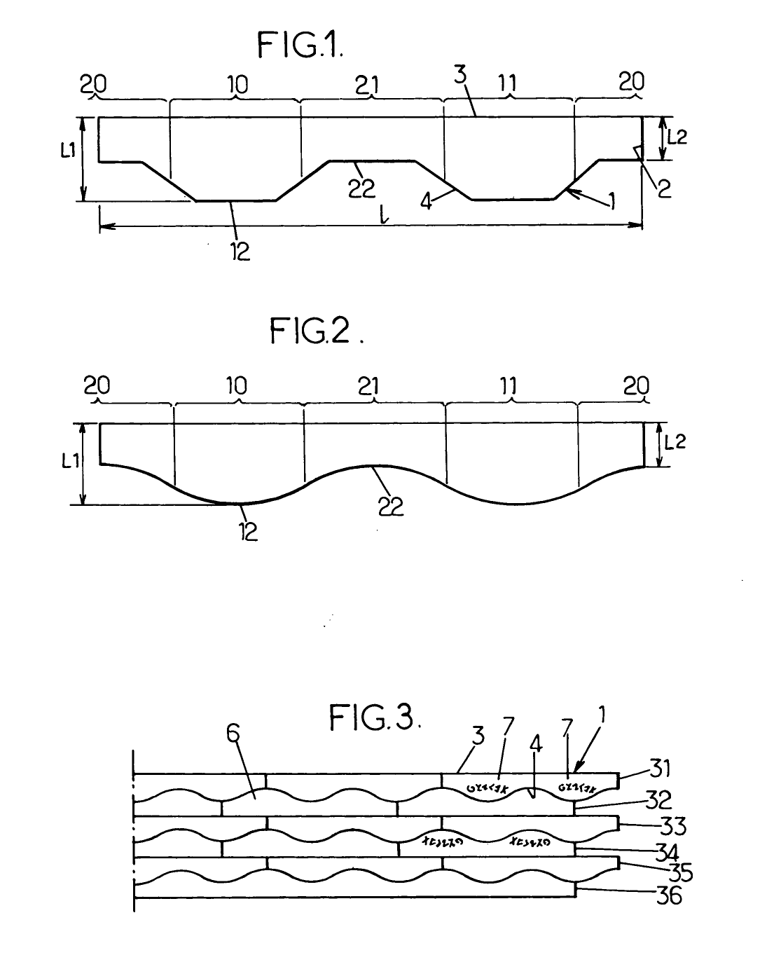

The minimum width L2 or maximum width L1 may be achieved over an entire segment (12, 22) of the corresponding portion, as appears in the embodiment illustrated in FIG. 1, or solely at one point (12, 22) of each portion, as appears in the embodiment in FIG. 2.

The bands illustrated in FIGS. 1 and 2 have two portions of maximum width (10, 11) and two portions of reduced width (20, 21), but the number of portions could be different. It is possible, in particular, to provide a single portion of maximum width and a single portion of reduced width.

To achieve the object of the invention, the minimum width L2 must be substantially smaller than the maximum width L1; to be precise, the portions of reduced width (20, 21) must make it possible to reduce the total area of the band, as compared with bands conventionally used which have a rectangular shape of width L1 and of length 1. This reduction in area of the band, of course, brings about a reduction in the film material used, and consequently a reduction in the cost of the band. This reduction in area likewise reduces the weight of the packaging provided with the band and limits the printed area, this having a positive influence on the overall production costs of the food packagings.

It is considered that, in order to obtain a significant cost reduction, the minimum width L2 must be at most equal to two thirds of the maximum width L1. However, the ratio between the maximum and minimum width (L1, L2) may vary, depending on the extent of the segments or points (12, 22) on which the maximum and minimum width is reached, and depending on the saving which is to be made.

Moreover, should the band have a plurality of portions of reduced width (20, 21), it is not absolutely necessary for all these to reach the same minimum width L2. The same applies to the portions of maximum width (10, 11). However, the mean width of the second portions (20, 21) must be smaller than the mean width of the first portions (10, 11).

It will be noted that keeping portions of maximum width (10, 11) makes it possible to print on the band logos and images of considerable size, preferably of a size equal to that of those used hitherto, which can be seen clearly by the consumer. The band produced according to the invention thus preserves its function of providing the consumers with information.

For this purpose, the maximum width L1 is substantially equal to the maximum height H of the lateral wall of the food packaging which will be described in detail below.

As can be seen from FIGS. 1 and 2, the first longitudinal edge 3 of the band is rectilinear and parallel to the longitudinal axis of the latter. Keeping a rectilinear edge similar to one of the edges of the rectangular bands previously used makes it possible to implement the bands according to the invention in known production machines, without considerable modifications to these. To be precise, the rectilinear edge 3 makes it easier to guide the bands during their conveyance and makes it easier to place them correctly with respect to the pots during the banding operation.

In the embodiment illustrated in FIG. 1, the second longitudinal edge 4 is formed from longitudinal segments (12, 22) connected by means of inclined segments, so that the second edge 4 has the profile of a broken line. However, the second edge 4 may have the profile of a continuous wavy line, as can be seen in FIG. 2. This arrangement makes it easier to cut out the second edge of the band, whether this is carried out with the aid of rotary knives or with the aid of a laser device described in detail below. To be precise, it is easier for a cutting-out device to follow a continuous line than a line having pronounced angles.

The profile of the second edge 4 may be a sinusoidal wavy line, but it is possible to increase or decrease the amplitude of the waviness or not to center the latter on the portions of maximum width or of reduced width, the exact profile of the wavy line being determinable for esthetic reasons.

Along the first portions (10, 11), the second edge 4 of the band has a convex profile, the vertex of which is defined by the segment or point 12. While, along the portions of reduced width (20, 21), the second edge 4 of the band has a concave profile, the maximum cavity of which is reached at the segment or point 22. As is more clearly apparent in FIG. 3, the convex profiles of the portions of maximum width (10, 11) are complementary to the concave profiles of the portions of reduced width (20, 21). It will be noted that the portion of reduced width 20 comprises the ends 2 of the band, thus making it possible to place the zone of overlap or of abutment of the ends in a less visible zone of the packaging. However, when the band surrounds the packaging, the portion 20 has a concave profile complementary to the convex profile of the portions of maximum width 10 or 11.

The minimum width L2 may be greatly reduced in relation to the maximum width L1 for the purpose of making a considerable saving in terms of film material. However, so as not to reduce the tensile strength of the band to too great an extent, the minimum width L2 is at least equal to one third of the maximum width L1. Thus, it is possible to convey the bands in known machines without the risk of tearing these bands. As an indication, the maximum width L1 is 36 mm and the minimum width L2 is 18 mm, that is to say half of L2, for the embodiment in FIG. 2.

The bands illustrated in FIGS. 1 and 2 can be cut out from a strip of film material 6, as illustrated in FIG. 3. The strip of film material 6 has designs 7 which may cover the strip 6 more or less completely. The arrangement of these designs defines the contour of the bands which may be cut out from this strip. These contours are represented symbolically by continuous lines in FIG. 3, but these are not cutting or precut-out lines previously made on the strip 6.

The printed designs 7 are printed on the strip 6 so as to define the contours of an even number of rows (31, 32, 33, 34, 35, 36) of bands arranged side by side in the direction of width of the strip. The bands thus defined by the designs 7 are arranged such that the second edges 4 of two successive rows are adjacent, and such that the first edge 3 of the first row 31 is contiguous to the longitudinal edge of the strip 6 and the first edge of the last row 36 is likewise contiguous to the other longitudinal edge of the strip 6.

This head-to-tail arrangement of the bands, with a longitudinal offset of two adjacent bands which positions the concave and convex profiles one opposite the other, makes it possible to use the entire film material of the strip 6, without any waste being produced. Thus, although the bands according to the invention have a more complex contour than conventional rectangular bands, there is no loss of film material during production, thus allowing an additional saving to be made.

FIGS. 4 and 5 illustrate a food packaging 40 of the yoghurt pot type which is surrounded by a band 1 produced according to the invention.

The packaging 40 comprises a pot 41 closed by means of a tear-off cap. The thermoplastic pot 41 is produced according to a known thermoforming method, as described, for example, in the document FR-A-2 759 320, which involves preheating a sheet of thermoplastic and then deep-drawing the latter in molds, a band previously being positioned against the lateral wall of said molds.

To produce food packagings, this operation of forming the pot is generally followed by an operation of filling with the food product, immediately followed by an operation of closing by means of a cap. This method is carried out by means of an FFS production machine (Form, Fill and Seal).

This type of packaging 40 for which the band is intended has a capacity generally of between 10 and 500 ml, and, for example, of approximately 200 ml in the embodiment illustrated.

The pot 41 has a bottom 43, which, in the embodiment illustrated, rises somewhat considerably toward the lateral wall 44. However, the pot could, of course, have a cylindrical shape, and in this case the bottom 43 would be formed solely by the lower disk of the cylinder. The lateral wall 44 is annular and extends vertically as far as a radially outer rim which surrounds the aperture of the pot. A cap is fitted onto the rim of the pot so as to form the upper face 42 of the packaging.

As may be gathered from FIGS. 4 and 5 which respectively illustrate a front view and a side view of the packaging 40, the cross section of the packaging is substantially in the shape of a rectangle with rounded corners. In this embodiment where the bottom 43 rises to a greater or lesser extent, the lateral wall 44 has a maximum height H at the center of the large side of the packaging. However, where a cylindrical pot is concerned, the height H of the packaging would be equal to the cylinder height.

The portion of maximum width 10 of the band 1 is arranged on the large side of the packaging, as can be seen in FIG. 4, and the maximum width L2 is substantially equal to the height H. The design 7 of the band is therefore sufficiently extensive to maintain the information and decoration function of the band. Of course, the width L1 of the band may be a few millimeters smaller than the height H of the pot, while at the same time preserving the visual qualities of the band; as an example, in the embodiment illustrated, the height H is 38 mm and the width L2 is 36 mm.

To produce bands according to the invention, a method may be adopted which comprises a step of cutting out the longitudinal edges of the bands, followed by a step of cutting the ends of the bands. However, it is perfectly possible to cut out bands in a single step, in particular with the aid of a die possessing a cutting edge according to the contour of the band.

During the step of cutting out the longitudinal edges, it is advantageous if at least the cutting out of the second edge 4 is carried out by means of a laser device comprising a movable laser beam, the movements of which are controlled so as to follow the concave and convex profiles of this second edge.

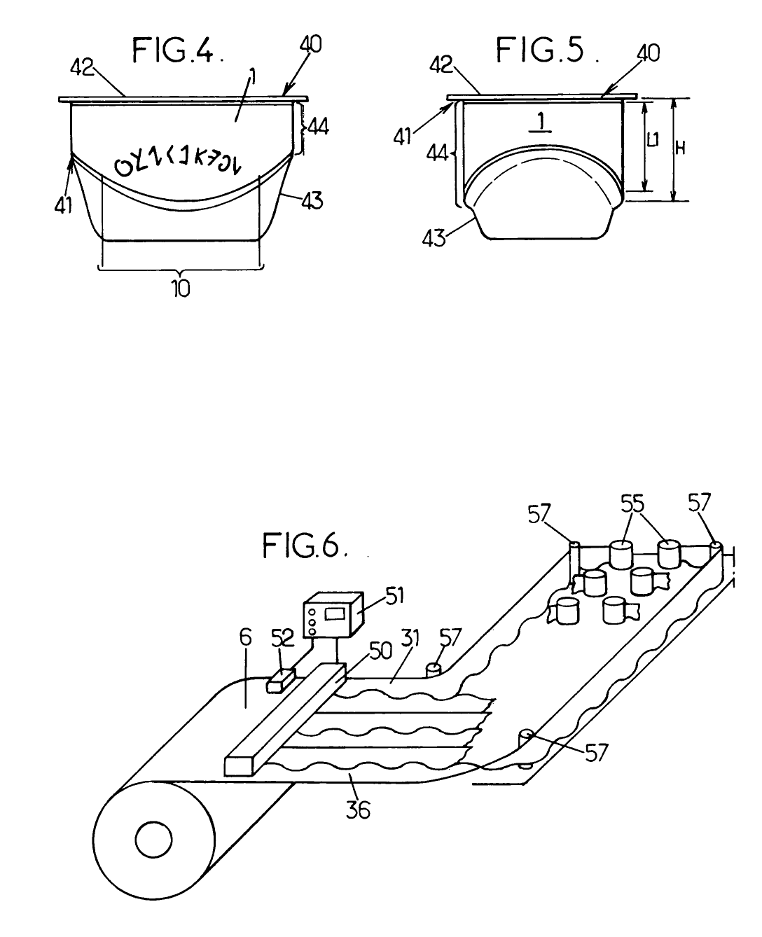

The laser may be of any known type and be designed to cut out a paper sheet or a plastic film. In a known way, the laser device may generate one or a plurality of cutting-out beams, as in the device 50 illustrated in FIG. 6. The movements of the beam or beams are generated by means of servomotors acting, for example, on mirrors. The servomotors are themselves controlled by means of a control device 51 which contains one or more servomotor management programs, so that the laser beams execute one or more cutting-out lines.

The use of a laser device thus makes it possible to cut out the second longitudinal edge 4 of the bands along a complex line and affords the possibility of changing virtually instantaneously from the production of a first band shape to a second band shape, simply by the input of a code into the control device 51.

Moreover, a laser device has the advantage, as compared with a device with rotating knives or with cutting dies, of not undergoing either wear phenomena or soiling phenomena, this being particularly important in the field of food packaging.

The rectilinear edges may, of course, likewise be cut out by means of a laser beam.

The cutting out of the bands by means of the laser cutting-out device is preferably carried out in a strip of film material, as described above.

As may be seen in FIG. 6, the strip 6, stored in the form of a roll, is unwound so as to travel with respect to the laser cutting-out device 50 arranged transversely with respect to the direction of travel. On account of this movement of the strip 6 with respect to the device 50, it is possible to control the displacement of the beams only in a direction transverse to the strip, thus avoiding the need to control an additional movement in the longitudinal direction of the bands.

A device 52 designed for detecting the movement of the strip 6 is connected to the control device 51, in order to synchronize the movements of the laser beams with the travel of the strip. The device 52 may be a device for the optical recognition of the designs printed on the strip or of any other marking applied to the latter.

The cutting out of the bands is integrated into the machine for the production of the packaging pots 41. This is a machine of the FFS type which includes a thermoforming station comprising molds represented symbolically by the reference 55.

The step of cutting out the longitudinal edges is followed by a step of conveying the striplets 31, 36 corresponding to the rows of the strip 6 which have been cut out longitudinally. This conveying step is carried out with the aid of pulleys and belt drives 57 of known types and does not require any substantial modifications on account of the first rectilinear edge 3 which makes it easier to guide the striplets.

It will be noted that, during the conveyance of the bands, the even rows (32, 34, 36) experience a reverse rotation with respect to the odd rows (31, 33, 35), in order to arrive at the molding stations with the same vertical orientation.

Once conveyed into the region of the molds 55, the bands are introduced into these, before the thermoforming of the pots, and are cut transversely with the aid of a known cutting-knife system in order to form the ends of the bands.

In the embodiment illustrated, this a machine making it possible to produce six pots simultaneously, but, of course, it could be a machine making it possible to produce twelve or twenty-four pots at a time.

1.-12. (canceled)

13. A decorative band intended for surrounding the periphery of a food packaging (40) which comprises a lateral annular wall (44) extending between a bottom (43) and an upper face (42), said band extending longitudinally between two ends (2) and having a first and a second longitudinal edge (3, 4), characterized in that it has at least one first portion (10, 11) extending longitudinally, which has a maximum width Li, and at least one second portion (20, 21), which has a minimum width L2, said minimum width L2 being between one third and two thirds of the maximum width Li, and in that the first edge (3) is rectilinear and substantially parallel to the longitudinal axis of the band.

14. The band as claimed in claim 13, wherein the second edge (4) has a convex profile along the first portion (10, 11) and a concave profile along the second portion (20, 21), said convex profile being complementary to said concave profile.

15. The band as claimed in either claim 13, wherein the second edge (4) has the profile of a continuous wavy line.

16. The band as claimed in claim 13, wherein the maximum width Li is substantially equal to the maximum height H of the lateral wall (44) of the food packaging (40)

17. A strip of film material comprising printed designs (7), characterized in that the printed designs define, in the direction of the width of the strip (6), the contour of an even number of rows (31, 32, 33, 34, 35, 36) of bands as claimed in claim 14, said bands (1) being arranged such that the second edges (4) of the bands of two successive rows are adjacent, and such that the first edge (3) of the first row (31) and the first edge of the last row (36) are contiguous to the longitudinal edges of the strip (6)

18. A food packaging having a lateral annular wall (40) extending between a bottom (43) and an upper face (42), characterized in that the periphery of the lateral wall is surrounded by a decorative band as claimed in claim 13.

19. The food packaging as claimed in claim 18, wherein the lateral annular wall (44) has a cross section which is substantially in the shape of a rectangle with rounded corners, and in which at least one first portion (10) of maximum width Li is arranged on a large side of the lateral wall of the packaging.

20. A method for the production of bands as claimed in claim 13, characterized in that it comprises a step of cutting out the longitudinal edges (3, 4) of the bands, in which at least the cutting out of the second edge (4) of the bands is carried out by means of a device (50) comprising at least one movable laser beam, in such a way that the minimum width L2 of the bands is between one third and two thirds of the maximum width Li, and the first edge (3) is rectilinear and substantially parallel to the longitudinal axis of the band.

21. The method for the production of bands as claimed in claim 20, wherein the step of cutting out the longitudinal edges is carried out in a strip of film material (6) as claimed in claim 5, which travels with respect to the laser cutting-out device (50), the movements of the laser beam being synchronized with the travel of the strip.

22. A method for the production of food packagings as claimed in claim 18, comprising a step of thermoforming the packagings (40) in molds (55), characterized in that it comprises a step of cutting out the longitudinal edges of the bands as claimed in claim 9, followed by a step of delivering the striplets thus obtained as far as the molds, and by a step of cutting out the ends (2) of the bands, which is carried out in the vicinity of the molds.

23. A method for the production of food packagings as claimed in claim 19, comprising a step of thermoforming the packagings (40) in molds (55), characterized in that it comprises a step of cutting out the longitudinal edges of the bands as claimed in claim 9, followed by a step of delivering the striplets thus obtained as far as the molds, and by a step of cutting out the ends (2) of the bands, which is carried out in the vicinity of the molds.
